(19) United States
(12) Patent Application Publication
(10) Pub. No.: US 2008/0314306 A1
(43) Pub. Date: Dec. 25, 2008

(54) Bimini misting system

(76) Inventors: Michael Santa Cruz, Pomona, CA (US); Robert Santa Cruz, Alta Loma, CA (US)

Correspondence Address: MICHAEL A. SHIPPEY, PH. D., LAW OFFICES OF KARLA SHIPPEY, 4848 LAKEVIEW AVENUE, SUITE E, YORBA LINDA, CA, 92886, US

(21) Appl. No.: 11/820,641

(22) Filed: Jun. 20, 2007

(51) Int. Cl. B63B 17/00; B05B 1/14

(52) U.S. Cl. 114/343; 239/268

(57) ABSTRACT

The present invention is a water misting device built in to a boat's bimini framework. The water for the device is taken from a lake, river, ocean or any other water body or source, and pumped through a screening or filtration system for endless misting opportunity. As the device is concealed within the framework, it is aesthetically pleasing to the boat owner and fellow boaters. The device can also be completely removed and reattached at the owner's discretion.

### RELATION TO PRIOR ART

None.

This is an original application for patent. No federal funds were used in the development of the invention described herein.

### FIELD OF THE INVENTION

The present invention relates to a misting system and more particularly pertains to a new misting system on a boat using the water from the ocean, a river, lake, or other body of water and pumping it through said system to provide a cooling, misting spray when desired by the boaters.

### DESCRIPTION OF RELATED ART

There are many heat related deaths each year. Taking into account all possible deaths that could be heat-related from 1999 to 2003, heat-related deaths increased by 54 percent, suggesting that the number of heat-related deaths had previously been underestimated. During this period, a total of 3,442 deaths resulting from exposure to extreme heat were reported, or about 688 deaths a year. Most of the deaths, 66 percent, were among men. With this type of climate the boating industry is soaring. The present invention provides a cost effective cooling method that is visually appealing, easily manufactured and efficiently marketed.

Other misting systems are known in the art, for example, U.S. Pat. No. 6,857,583 (Attar, R. A., Feb. 22, 2005) discloses a boat pressure washing system using the lake, river or other water reservoir to pump through the system.

U.S. Pat. No. 7,077,338 (Williamson, R. C., Jul. 18, 2006), discloses the misters to be permanently placed in the hull of the boat and extended to the or roofing using tubular supply lines and clips.

U.S. Pat. No. 6,175,969 (Edwards, H. A., Jan. 23, 2001) discloses a boat-supported water misting and cooling apparatus using clips to attach supply lines to the tubular framework pumping the water from an on-board fresh water tank.

U.S. Pat. No. 5,628,273 (Crouse II, D. E., May 13, 1997) further discloses a water misting system that attaches tubing with hose ties and clips to the framing structure of the boat.

None of these inventors conceal the mister in the existing bimini railings, but rather use tubing and clips. Furthermore, some of the prior art calls for the hull (structure) of the boat to be permanently compromised on installation, as holes must be drilled in the hull to place the spray nozzles.

### SUMMARY OF INVENTION

The present invention comprises a boat misting system that provides a fine water mist for cooling boaters. The system draws water from a lake, river, ocean or other water body or source, and disperses it as a mist into the boat through the existing frame work of the bimini using a plurality of misting spray nozzles.

It is therefore the primary object of the present invention to provide a device that is aesthetically pleasing to the boat owner and that of the occupants concealing the spray nozzles into the existing and detachable bimini without permanently drilling or cutting into the boat structure to place the spray nozzles.

It is a further object of the present invention is to provide a device that can be easily and quickly installed on-site.

It is another object of the present invention to provide a pump with a built-in filtration system that will utilize a pressurized system to maintain a constant or intermittent spray.

Other objects and advantages of the present invention will become apparent from the following descriptions, taken in connection with the accompanying drawings, wherein, by way of illustration and example, an embodiment of the present invention is disclosed.

### BRIEF DESCRIPTION OF DRAWINGS

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

FIG. 1 depicts a Bimini of the current invention, from an upper perspective view, mounted on a boat. The boat itself forms no part of the current invention.

FIG. 2 illustrates the upper portion of a Bimini rail, adapted as per the current invention to include a misting system.

FIG. 3 presents a detailed view of a magnified portion of a Bimini of the current invention, showing detail of the mister heads and their installation.

FIG. 4 illustrates the lower portion of the above-deck component of the current invention, showing detail of water bypass and manual draining systems.

FIG. 5 follows the current invention in the elements that connect the above-deck component to the below-deck component.

FIG. 6 continues the current invention in displaying the below-deck component.

FIG. 7 displays a side view of the manual draining system.

FIG. 8 illustrates a schematic-like view of the current invention, including the power source.

FIG. 9 shows an expanded view of a mister head, and cross section of the local area of Bimini rail.

FIG. 10 presents a side view of the deck-level bezel of the current invention, including both the above-deck cap with openable cap, and the below-deck securing nut.

FIG. 11 shows a side view of the deck-level bezel of the current invention, including the water supply line that is secured by the bezel.

FIG. 12 presents a cutaway view of the deck-level bezel of the current invention, including a view of the water supply line proceeding from below-deck to above-deck.

FIG. 13 shows an expanded view of the deck-level bezel of the current invention, with water supply line removed, and cap removed from nut.

FIG. 14 illustrates a side view of the deck-level bezel of the current invention, demonstrating the cap opening feature.

FIG. 15 shows an expanded view of the deck-level bezel of the current invention, from, an underneath perspective, with water supply line removed.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

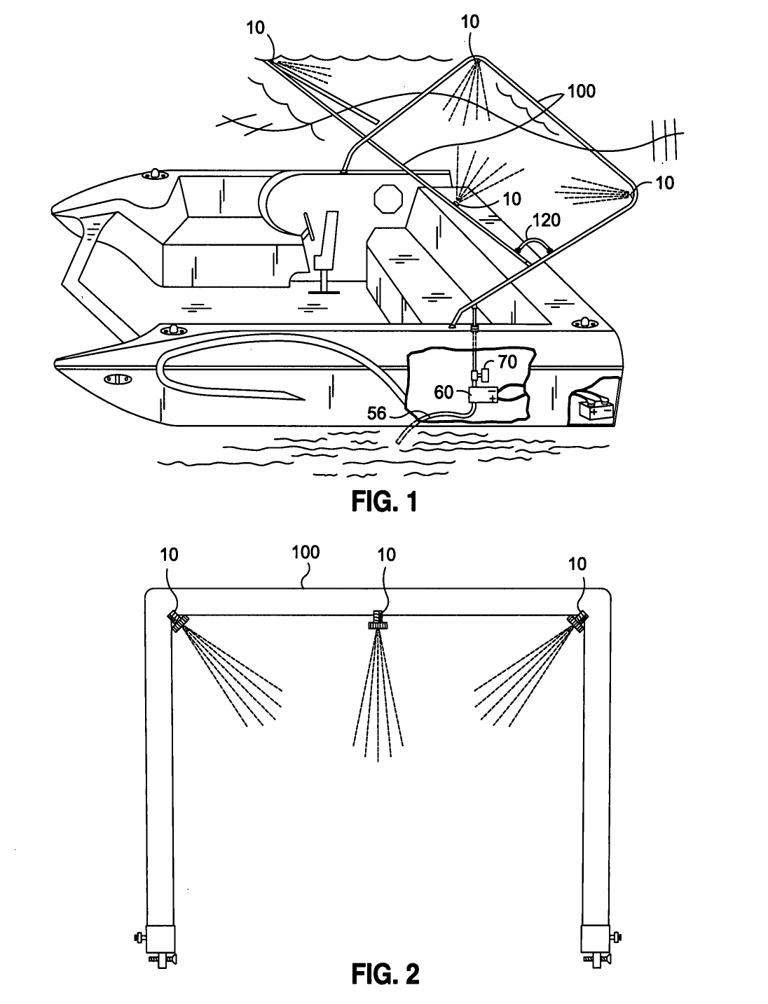

The present invention, as depicted from an upper perspective view in FIG. 1, is a new and improved Bimini rail system that employs a misting system that draws water from the freshwater body of water on which the boat travels. The misting system draws water from a water source through water inlet pipe 56. The water source most preferably is the body of water on which the boat is traveling, provided it contains fresh water. Alternatively, if the boat is situated on salt water, the water source may be a fresh water tank held on board, preferably lower in the hold.

As depicted generally in FIG. 1, water travels through water inlet pipe 56 upward to Bimini rails 100. The water is propelled by a pump 60, and filtered through filter 70 to remove particulates that might interfere with the misting system. The water traverses the Bimini rail 100, which is hollow and acts as a pipe. Mister heads 10 are embedded in the rails at various points along the line. These emit water as a fine spray, to cool persons on the boat in hot weather conditions.

In the preferred embodiment, the misting system is controlled by a power switch mounted on the boat deck. This switch controls power to the pump 60. When turned on, the pump cycles water through the Bimini rails to the mister heads, which operate automatically to deliver a mist or spray to the boat deck. When the switch is turned off, the pump stops, and no water is delivered to the mister heads. Hence, no misting occurs.

FIG. 2 shows the mister heads 10 in detail at the top of the Bimini rail 100. The mister heads can be located anywhere along the rail. Preferably the mister heads 10 are located in elevated sites, as shown in FIG. 2. This allows the fine mists to descend over the heads of the boat passengers, which enhances the cooling effect.

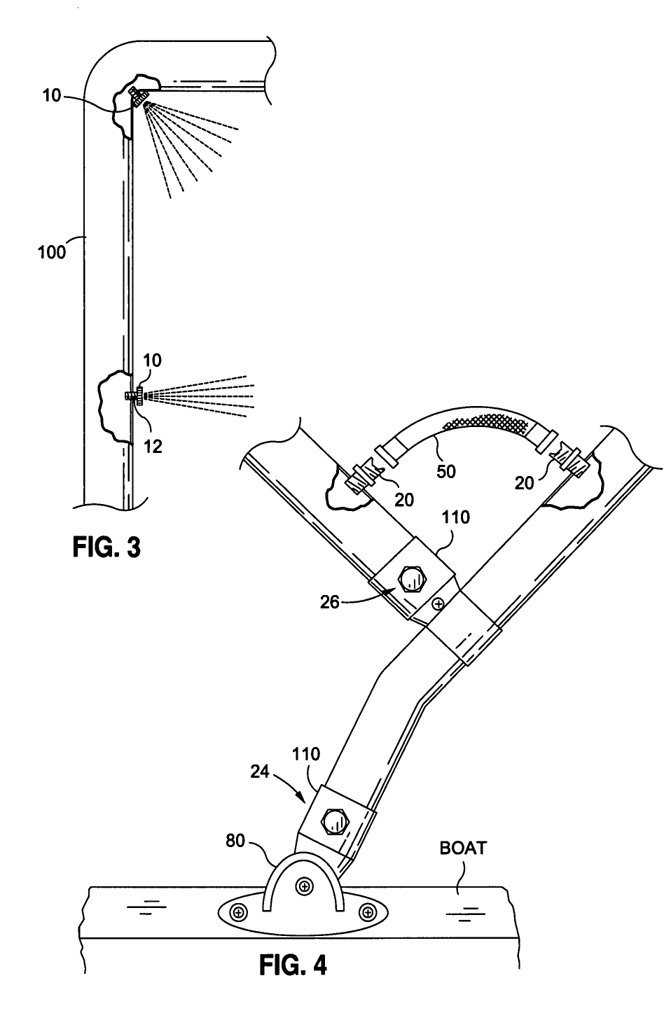

FIG. 3 shows detail of a section of the Bimini rail 100 with mister heads 10. The mister heads are tapped directly into the Bimini rail. Preferably the insertion tube 12 portion is threaded, to form a tight seal to avoid leakage of water.

After passing the mister heads, water may exit by any of three avenues. The water that enters the mister heads is converted into mist, and will either evaporate, or condense and fall onto the boat deck, where it ultimately will be drained into the body of water over which the boat is traveling. The water that avoids exiting through the mister heads will be recirculated until the system is shut down. The water then descends by gravity to the lower part of the Bimini rails. There it meets the drainage and recycling portion of the system, shown in FIG. 4.

The standard Bimini rails 100 are capped at their ends with an end cap 110, as seen in two locations within FIG. 4, at the bottom of each rail. Since the ends are capped off, they cannot transmit water. The present invention comprises two separate means to transmit water that might otherwise be trapped in the lower ends of the Bimini rails.

The first such adaptation is a bypass pipe, seen at the top of FIG. 4. The bypass consists of a ¼ inch stainless steel braided pipe 50, connected at each end via ¼ stainless steel pipe nipples 20 to the interior of a Bimini rail. This allows water to circulate around the Bimini rail system when the pump is in operation.

Also present in FIG. 4 are four push button drain systems 24 and 26. When depressed, these allow water at the lower ends of their respective rails to drain out. These are normally used after the end of a misting cycle, when the pump is shut down, to drain the Bimini rails of any residual water within the system. At the bottom of the lower rail is the attachment stanchion 80 for the Bimini on the boat deck.

It will be appreciated that the present invention can comprise, in one preferred embodiment, a new and improved Bimini with a built-in misting system. In an alternate preferred embodiment, the invention comprises a retro-fit to an existing Bimini on a boat. Provided the exiting Bimini rails are made of stainless steel, or similar corrosion-resistant material, and the system is relatively new and durable, it can be retrofit to comprise a misting system of the present invention, as will be described further.

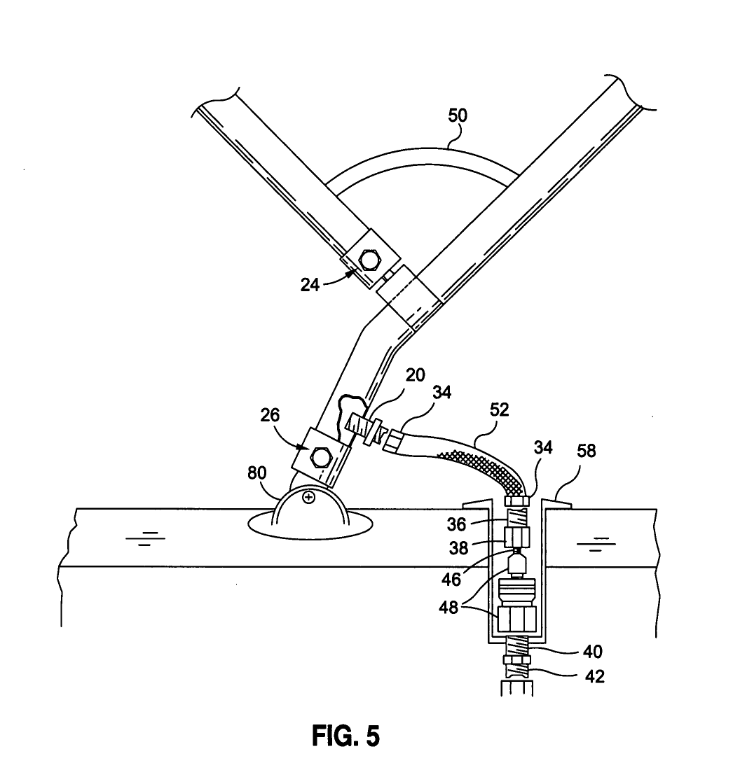

FIG. 5 displays the connection of the above-deck system of the present invention with the water supply from below the deck. At the lowest end of the Bimini rail 100, it connects to another length of ¼ inch stainless steel braided pipe 52, connected via a ¼ stainless steel pipe nipple 20. The other end of pipe 52 connects via a ¼ compression nut 36 to a male 46 and female 48 reducing adapter pair to a ⅜ coupler nipple 40, then via a ⅜ compression thread 42 to a ⅜ compression nut 44, and thence to water supply line 54. In a preferred embodiment, male 46 and female 48 reducing adapter pair are of the quick-disconnect design. In combination, the units comprising the interface between above-deck and below-deck supply lines is termed connector system 110, and is seen in detail in FIG. 12. The entire section connects from above deck to below deck via a hole in the deck or rail. This hole is covered by a special bezel 58, which is installed at the top of the hole to enhance the final appearance. This allows the above-deck portion of the current invention to be easily separated from the below-deck portion. This aids in servicing of the invention.

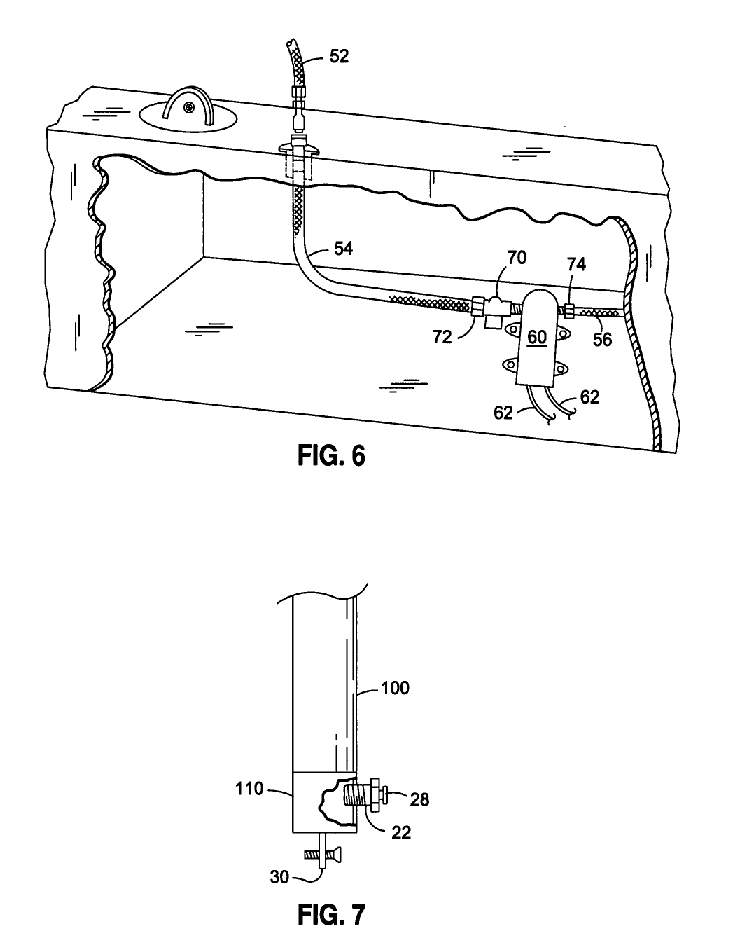

The detail of the water supply continues in FIG. 6. The connection from line 52 is reproduced at the top of this figure, as first seen in FIG. 5. Through a cutaway view through the boat hull, we see water supply line 54 continuing down below the deck, and connecting via compression nut 72 to filter 70. Filter 70 is designed to keep small particulate mater out of the misting system. Such matter, if not removed, could clog and impede the mister heads. Such filters are well known in the art. One particular brand of filter that works well in a preferred embodiment of the current invention is the Shurflo® Model 255 strainer. This is available from the Shurflo company, 5900 Katella Road, Cypress, Calif. 90630, website www.shurflo.com.

Immediately next to the filter 70 is the pump 60. The pump provides the driving force for moving water upward through the Bimini rail system and to the mister heads. This requires a pump supplying suitable pressure to the water. Such pumps are well known in the art. One particular brand of pump that works well in a preferred embodiment of the current invention is the Shurflo® Blaster series pump. This also is available from the Shurflo company, 5900 Katella Road, Cypress, Calif., 90630, website www.shurflo.com.

The pump 60 is of course electrically powered. Power comes from the battery of the boat, through electrical lines 62. The filter 70 in the preferred embodiment needs no power. Alternatively, an electrical filter can be powered from the boat's battery in the same manner. Although not shown in the figures, a timer may be installed to control operation of the pump, so that it starts the misting on a regular basis. Installation of timers on a simple electrical circuit is well known in the art.

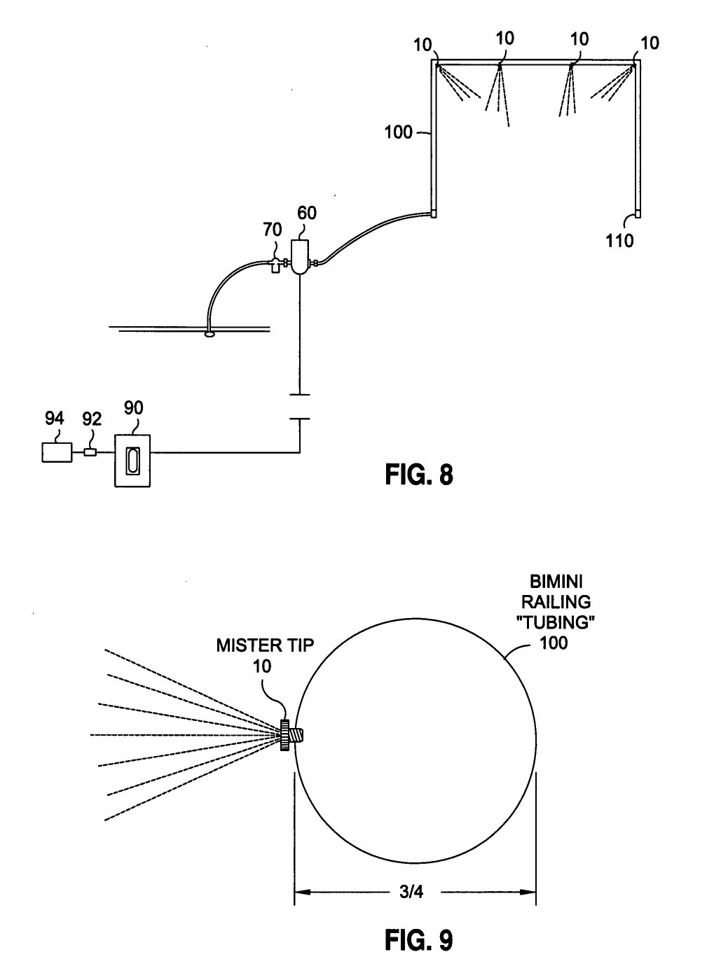

The pump is controlled by on-off power switch 94, shown in FIG. 8. The switch is preferably mounted above the deck, in a position easily reached by the pilot of the boat. When the power to the pump 60 is switched on, the pump is activated, and begins pumping water through the Bimini rails to the mister heads. These automatically begin the misting process. The process ends by switching power off to the pump.

Pump 60 is supplied water from the inlet line 56. This water line leads to the water source for the misting system. The water source can be any source of fresh water. Preferable in a fresh water environment, such as a river or lake, is to use the river or lake water as a source of water for the misting system of the current invention. Alternatively, the boat could carry an on-board tank of fresh water. This option is preferred in a salt-water marine environment, due to the corrosive nature of salt water. Nut 74 secures the inlet line 56 to pump 60. Inlet line 56 has a screen mounted on the end open to the water source. This screen will act as a first barrier to the entry of undesired particulate matter.

FIG. 7 shows detail in the end cap 110 of a Bimini rail 100. A push button drain 28 has been installed in the end cap. The push button is spring loaded, and has a pinhole 22. When the button 28 is pushed, it unlatches, and exposes pinhole 22. This allows water to drain out of the inside of Bimini rail 100, and onto the boat deck. From there, it exits to the outside of the boat via the water drain that is common on recreational boats.

Pivot point 30 connects the bottom of Bimini rail 100 to the boat deck or hull.

FIG. 8 shows an overall view, similar to a schematic, of the preferred embodiment of the present invention. The filter 70, pump 60, and battery 94 are depicted as the below-deck component of the present invention. The above-deck component includes the Bimini rail 100, end cap 110, and the mister heads 10. Water and electrical lines are also shown, but not identified in detail.

FIG. 9 shows the detail of a cross-section of a Bimini rail 100 with a mister head 10 installed. The Bimini rail 100 is ¾ inch in diameter, in a preferred embodiment of the current invention. This is much larger than the mister head 10. Thus the rail can easily sustain the flow of water required to sustain operation of several mister heads simultaneously. Provided the pump, filter, and water source are adequately sized, no real limitation will be imposed on the number of mister heads 10 employed on a boat.

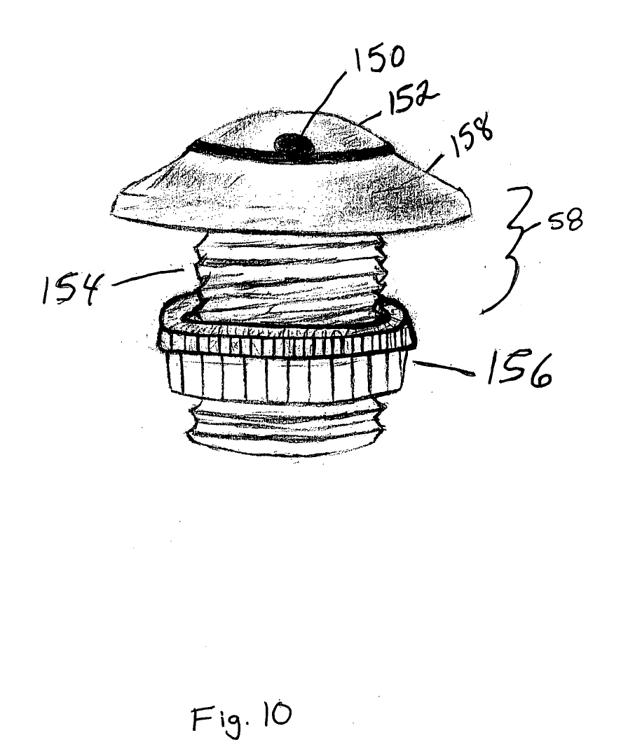

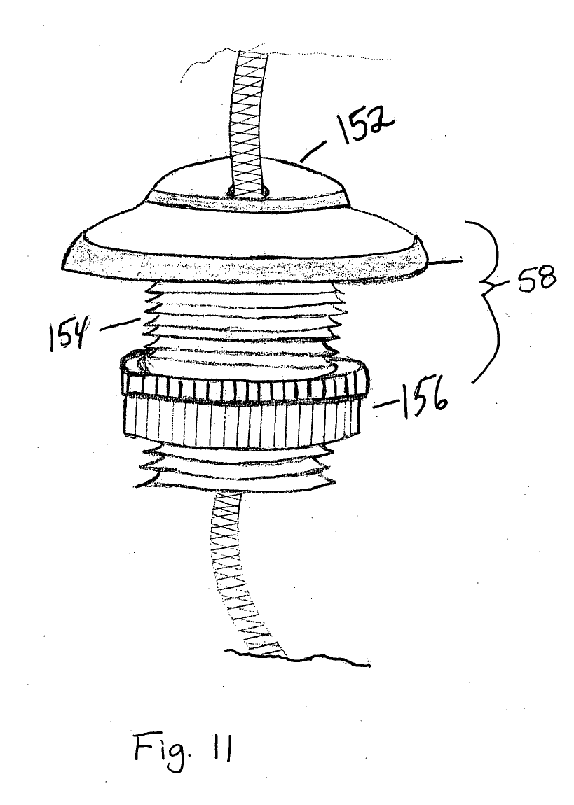

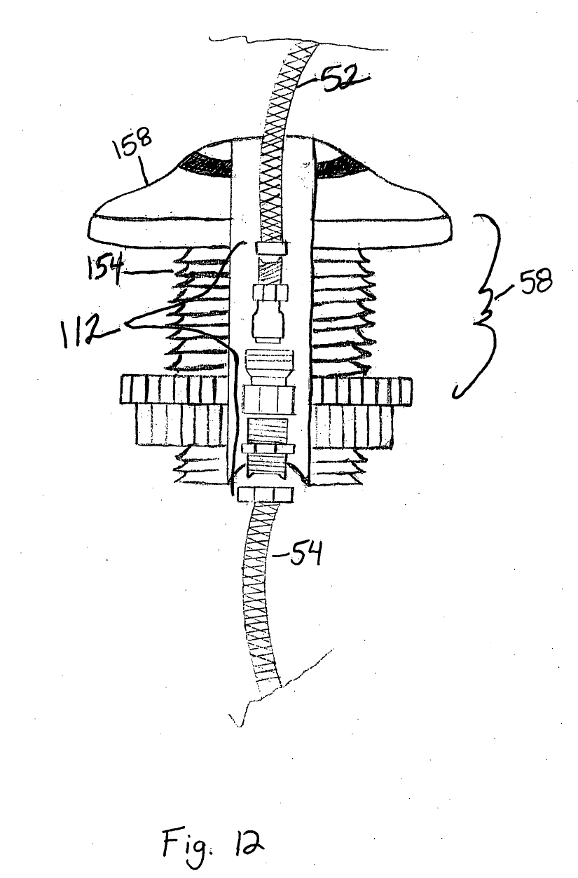

FIG. 10 shows a side view of the bezel 58 that forms the interface conduit for the water supply line at the level of the deck of the boat. The bezel comprises a cap 152, top portion 158, a threaded stem 154 fixedly attached to top 158, and a matching nut 156. Nut 156 can be threaded onto stem 154, and tightened to affix bezel 58 to the deck of the boat.

Cap 152 includes a through aperture 150, connected to a conduit through stem 154. This feature allows the braided water supply pipe 52 to pass through the aperture to the quick disconnect unit such as displayed in FIG. 5. The conduit inside stem 154 is much wider than the aperture 150, in order to accommodate the quick disconnect components. The arrangement is displayed in FIG. 11.

FIG. 12 portrays the bezel 58 from a cutaway side view. The cutaway shows the conduit that features the connection of above-deck water supply line 52 to its below-deck counterpart water supply line 54. The two lines are linked via connector system 110. Connector 110 preferably comprises a group of components that form a quick disconnect system for easy repair and maintenance.

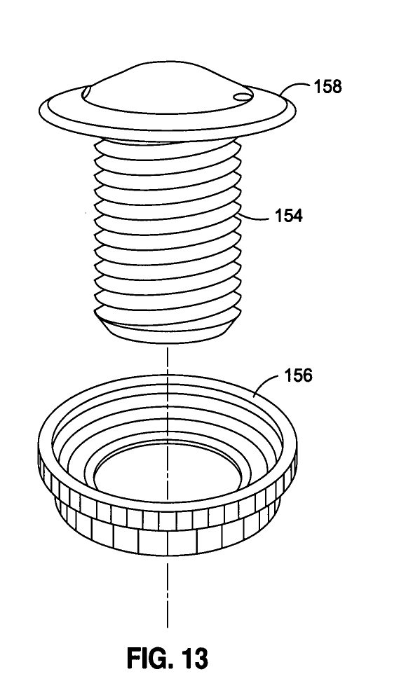

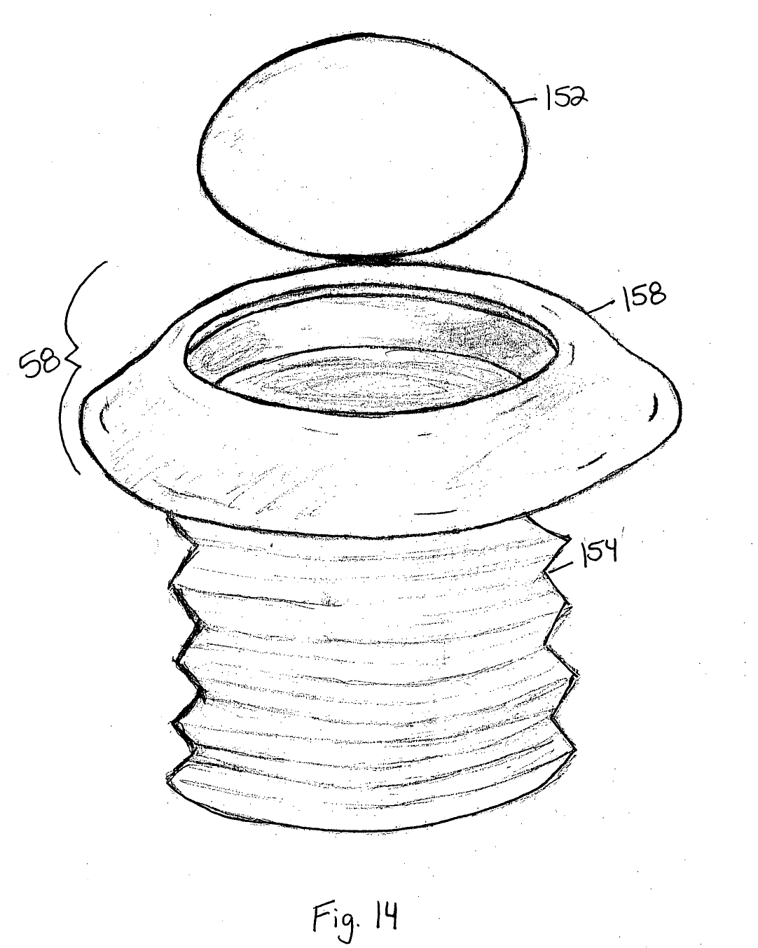

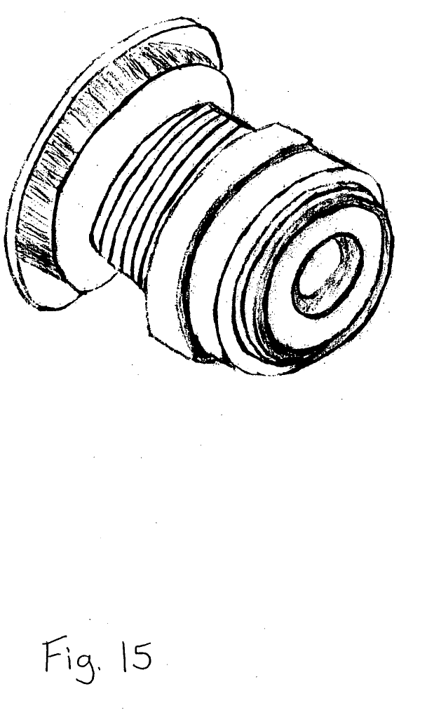

FIG. 13 shows another side view of bezel 58, with water supply lines absent. In this view, top 158 is unscrewed from matching nut 156. FIG. 14 shows yet another side view of bezel 58, with water supply lines absent. This view shows the cap 152 in open position from top 158. The open position is useful for above-deck maintenance or inspection of the water supply lines or the quick-disconnect interface. The bezel 58 is seen from an underneath perspective view in FIG. 15.

Although the invention has been described as a new apparatus, it also embodies a retrofitting of existing Bimini canopies and boats. The primary requirement for an existing Bimini to be suitable for retrofitting is that the rails be constructed of sturdy, water-impregnable, long lasting material. This translates in practice to new model, stainless steel Bimini rails.

To adapt such a suitable candidate Bimini with the current invention, the following steps are taken, comprising the retrofitting process:
1. A pump and filter screen are installed, with the pump connected to the battery of the boat. A power switch is installed.
2. A hole is cut into the deck, preferably along the rail or gunwale. A bezel 58 is installed at the top of the hole, to enhance the final appearance. The pipe fittings and water lines are installed, as depicted in FIGS. 5 and 6.
3. The water line 52 is joined to the interior of lower Bimini rail 100.
4. Push button drain systems 24, 26 are installed on end caps, as seen in FIG. 5.
5. The water bypass system 50 is installed, as seen in FIG. 4.
6. Mister heads 10 are installed. See FIGS. 2, 9.

The system can be completely removed by reversing the above process. Alternatively, the system can be disconnected, perhaps simply by removing the above-deck components, while leaving the below-deck, out-of-sight components intact, in the event the entire system should be needed at a later date.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

I claim:

1. A boat misting device comprising:
a plurality of spray nozzles installed into the frame of the detachable bimini;
a length of conduit connected to the framework of the bimini;
a spilt connection fitting connected to a length of flexible conduit;
a length of flexible conduit connected to the hull of the boat with quick disconnect fittings;
a supply line connected to an outlet on the water pump;
said water pump having a built-in filtration system; and,
a supply line connected to the inlet and to the water pump;
said inlet having a screen.

2. The boat misting system of claim 1, wherein each said spray nozzle has a swivel joint and a mist control tip.

3. The boat misting system of claim 1, wherein the control panel has a timer for cycling the pump.

4. The boat misting system of claim 1, wherein said conduit lines are concealable within a hull of the boat.

5. The boat misting system of claim 1 further comprising a plurality of reducers for connecting said supply outlet manifold to said conduit lines.

6. The boat misting system of claim 1 further comprising quick disconnects for attaching a length of extension tubing with a plurality of said spray nozzles for the purpose of extending a portion of said misting system to a bimini frame.

7. The boat misting system of claim 6 further comprising a bezel to house the quick disconnect system.

8. A retrofitting process for an existing Bimini rail and boat, said process comprising:
the installation of a pump and a filter screen, with the pump connected to the battery of the boat;
the installation of a power switch;
cutting a hole into the deck, preferably along the rail or gunwale;
the installation of a pipe fittings and water lines;
connection of a water supply line to the interior of a lower Bimini rail;
the installation of at least one push button drain device;
the installation of a water bypass system; and,
the installation of a plurality of mister heads along the Bimini rails.

9. A boat misting device comprising:
a plurality of spray nozzles installed into the frame of the detachable bimini;
a length of conduit connected to the framework of the bimini with quick disconnect fittings;
a bezel housing said quick disconnect fittings;
a spilt connection fitting connected to a length of flexible conduit;
a length of flexible conduit connected to the hull of the boat with quick disconnect fittings;
a supply line connected to an outlet on the water pump;
said water pump having a built-in filtration system; and,
a supply line connected to the inlet and to the water pump;
said inlet having a screen.
